(19) United States
(12) Patent Application Publication
(10) Pub. No.: US 2004/0009698 A1
(43) Pub. Date: Jan. 15, 2004

(54) Electrical connector with guiding structure for positioning circuit board

(76) Inventor: Shichao Jiang, Kunshan (CN)

Correspondence Address: WEI TE CHUNG, FOXCONN INTERNATIONAL, INC., 1650 MEMOREX DRIVE, SANTA CLARA, CA, 95050, US

(21) Appl. No.: 10/301,325

(22) Filed: Nov. 20, 2002

(30) Foreign Application Priority Data
Jul. 10, 2002 (TW) 091210505

(51) Int. Cl. H01R 13/64

(52) U.S. Cl. 439/377

(57) ABSTRACT

An electrical connector (1) for receiving a circuit board (2) therein. The connector includes an elongated insulative housing (10) defining a longitudinal slot (11) therein for receiving the circuit board. A multiplicity of evenly-spaced passageways (12) is defined in two sidewalls (13) of the housing that are at opposite sides of the slot respectively. A multiplicity of conductive terminals (14) is received in the passageways, for electrically connecting with the circuit board. A pair of guiding arms (130) extends upwardly from opposite ends of the housing respectively. Each arm defines a central guiding channel (131) therethrough, for guiding the circuit board into the slot and securely receiving the circuit board therein.

### BACKGROUND OF THE INVENTION

1. Field of the Invention

The present invention relates to an electrical connector for receiving a circuit board therein, and particularly to an electrical connector with guiding structures for positioning the circuit board therein.

2. Description of Related Art

There have been many developments and innovations of electrical connectors that receiving circuit boards and make electrical connection therebetween. Electrical connectors known as card edge connectors have been widely used for some time now. A typical card edge connector is described in “Properties of Card Edge Connector Spring/Tab Interface” (P460˜466, May 28, 2002). Other card edge connectors are disclosed in U.S. Pats. Nos. 4,869,672, 5,052,936 and 5,171,154.

Referring to FIG. 3, a conventional card edge connector 9 comprises an elongated insulative housing 90 defining a longitudinal slot 92 therein for receiving a circuit board 8. A multiplicity of evenly-spaced passageways is defined in two sidewalls of the housing 90 that are at opposite sides of the slot 92 respectively. A multiplicity of conductive terminals 91 is received in the corresponding passageways, for electrically connecting with the circuit board 8. The slot 92 is slightly wider than the thickness of the circuit board 8, and only a relatively small portion of the circuit board 8 is received in the slot 92. As a result, the circuit board 8 cannot be securely received in the slot 92. The circuit board 8 is prone to be damaged, especially when the connector 9 is subjected to shock or vibration during normal use. This can result in faulty electrical connection between the circuit board 8 and the card edge connector 9, or even failure of electrical connection.

In view of the above, a new electrical connector that overcomes the above-mentioned disadvantages is desired.

### SUMMARY OF THE INVENTION

Accordingly, an object of the present invention is to provide an electrical connector for securely receiving a circuit board therein, so that the circuit board maintains reliable electrical connection with the connector.

To achieve the above-mentioned object, an electrical connector in accordance with a preferred embodiment of the present invention is for receiving a circuit board therein. The connector comprises an elongated insulative housing defining a longitudinal slot therein for receiving the circuit board. A multiplicity of evenly-spaced passageways is defined in two sidewalls of the housing that are at opposite sides of the slot respectively. A multiplicity of conductive terminals is received in the passageways, for electrically connecting with the circuit board. A pair of guiding arms extends upwardly from opposite ends of the housing respectively. Each arm defines a central guiding channel therethrough, for guiding the circuit board into the slot and securely receiving the circuit board therein.

Other objects, advantages and novel features of the invention will become more apparent from the following detailed description when taken in conjunction with the accompanying drawings, in which:

### BRIEF DESCRIPTION OF THE DRAWINGS

FIG. 1 is an isometric view of an electrical connector in accordance with a preferred embodiment of the present invention, also showing a circuit board in dashed lines received in the electrical connector;

FIG. 2 is an enlarged cross-sectional view taken along line 11-11 of FIG. 1; and

FIG. 3 is an isometric view of a conventional electrical connector, also showing a circuit board in dashed lines received in the electrical connector.

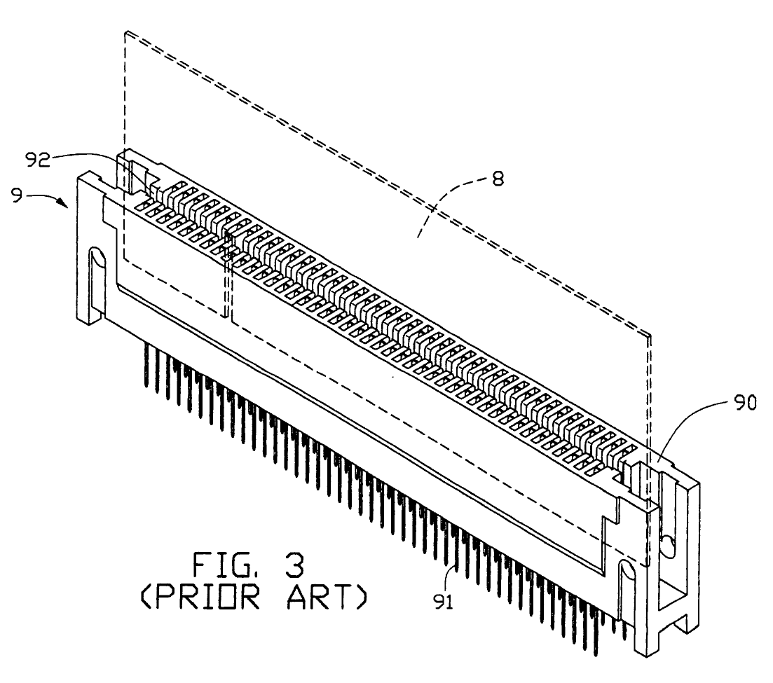

### DETAILED DESCRIPTION OF PREFERRED EMBODIMENT OF THE INVENTION

Reference will now be made to the drawings to describe the present invention in detail.

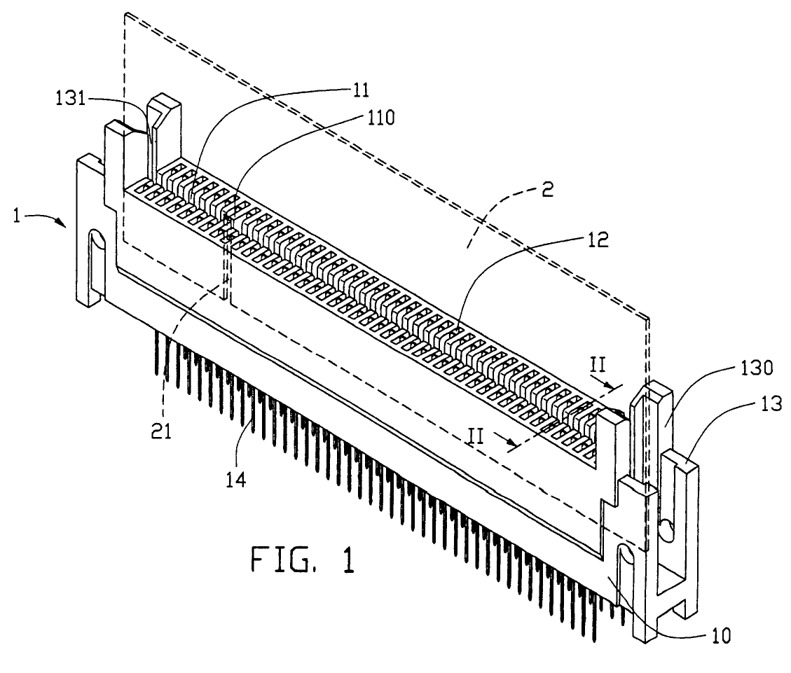

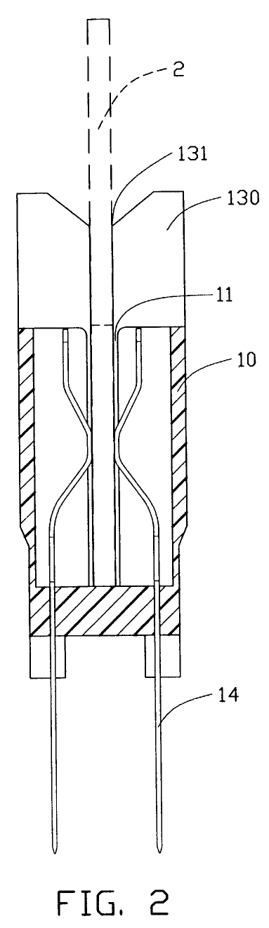

Referring to FIGS. 1 and 2, an electrical connector 1 in accordance with a preferred embodiment of the present invention comprises an elongated insulative housing 10 defining a longitudinal slot 11 therein for receiving a circuit board 2. A multiplicity of evenly-spaced passageways 12 is defined in two sidewalls 13 of the housing 10 that are at opposite sides of the slot 11 respectively. A multiplicity of conductive terminals 14 is received in the corresponding passageways 12, for electrically connecting with the circuit board 2.

A pair of protrusions 110 is respectively formed on the opposite sidewalls 13 of the housing 10. A cutout 21 is defined in the circuit board 2, for engagingly receiving the protrusions 110 of the housing 10. The protrusions 110 mate in the cutout 21, and provide the connector 1 with blind mating. This ensures that the circuit board 2 is correctly received in the slot 11.

The connector 1 further comprises a pair of guiding arms 130 extending upwardly from opposite ends of the housing 10 respectively. Each guiding arm 130 defines a central guiding channel 131 therein. Each guiding channel 131 has a V-shaped opening to facilitate insertion of the circuit board 2 thereinto. Furthermore, each guiding channel 131 is slightly wider than a thickness of the circuit board 2 and narrower than a width of the slot 1, so that the circuit board 2 is firmly held in the guiding channels 131 and securely received in the slot 11. This prevents the circuit board 2 from being damaged in the slot 11, especially when the connector 1 is subjected to shock or vibration during normal use. It also ensures that the circuit board 2 maintains reliable electrical connection with the connector 1.

While a preferred embodiment in accordance with the present invention has been shown and described, equivalent modifications and changes known to persons skilled in the art according to the spirit of the present invention are considered within the scope of the present invention as defined in the appended claims._{—}

What is claimed is:

1. An electrical connector for receiving a circuit board therein, the electrical connector comprising:
an insulative housing defining a longitudinal slot therein, and defining a plurality of passageways in two sidewalls that are at opposite sides of the slot respectively;
a plurality of conductive terminals received in the passageways; and
a pair of guiding arms extending in a same direction from opposite ends of the housing respectively, each of the arms defining a guiding channel therethrough;
wherein when the circuit board is received in the slot, a gap between the the circuit board and either of the guiding arms is smaller than a corresponding gap between the circuit board and one of the sidewalls, whereby the circuit board is guided into the slot by the guiding channels and securely received therein.

2. The electrical connector as claimed in claim 1, wherein each of the guiding channel has a V-shaped opening.

3. The electrical connector as claimed in claim 2, wherein each of the guiding channels is wider than a thickness of the circuit board and narrower than a width of the slot.

4. The electrical connector as claimed in claim 3, wherein at least one protrusion is formed in the housing for mating in a corresponding cutout of the circuit board.

5. An electrical connecting assembly comprising:
a circuit board; and
an electrical connector comprising an insulative housing and a plurality of electrical terminals received in corresponding passageways of the housing;
wherein the housing defines a longitudinal slot therein, a pair of guiding arms extends in a same direction from opposite ends of the housing, and each of the arms defines a guiding channel therethrough which is wider than a thickness of the circuit board and narrower than a width of the slot, whereby the circuit board is guided into the slot by the guiding channels and securely received therein.

6. The electrical connector as claimed in claim 5, wherein each of the guiding channels has a V-shaped opening.

7. The electrical connector as claimed in claim 6, wherein at least one protrusion is formed in the housing for mating in a corresponding cutout of the circuit board.

8. An electrical connector assembly comprising:

9. An electrical connecting assembly comprising:
a circuit board; and
an electrical connector comprising an insulative housing with a central slot and a plurality of electrical terminals disposed by two sides of the slot;
a pair of guiding arms extends upwardly from opposite ends of the housing, and each of the arms defines a guiding channel therethrough which is wider than a thickness of the circuit board and narrower than a width of the slot, whereby the circuit board is guided into the slot by the guiding channels and securely received therein; wherein
each of said guiding arms is composed of two opposite pieces each with an L-shaped cross-sectional configuration composed of a vertical section and a horizontal section thereof, and the guiding channel is defined between vertical sections of said L-shaped configurations of said two opposite pieces.
